(19) United States
(12) Patent Application Publication
(10) Pub. No.: US 2026/0202639 A1
(43) Pub. Date: Jul. 16, 2026

(54) CONTACT SYSTEM FOR ROTATIONAL SHUTOFF OF A NIGHT-VISION DEVICE

(71) Applicant: Low Light Innovations LLC, East Greenwich, RI (US)

(72) Inventor: Bradley Pupo, Bellbrook, OH (US)

(21) Appl. No.: 19/431,499

(22) Filed: Dec. 23, 2025

Related U.S. Application Data
(60) Provisional application No. 63/743,933, filed on Jan. 10, 2025.

(51) Int. Cl. G02B 7/12; G02B 23/12; G02B 23/18

(52) U.S. Cl. CPC G02B 7/12; G02B 23/125; G02B 23/18

(57) ABSTRACT

Embodiments of the present disclosure include a night vision device. In some embodiments, the night vision device can include a first housing. In some embodiments, the night vision device can include a second housing, wherein the first housing is configured to rotate relative to the second housing about a pivot point that defines an axis about which the first housing rotates. In some embodiments, the night vision device can include a rotational electrical circuit disposed about the pivot point, wherein the rotational electrical circuit includes a contact track fixed with respect to the second housing. In some embodiments, the night vision device can include an electrical contact fixed with respect to the first housing, wherein rotation of the first housing about the pivot point causes selective electrical engagement between the electrical contact and the contact track, dependent on a rotational position of the first housing, and wherein the selective electrical engagement between the electrical contact and the contact track is established or interrupted based on the rotational position of the first housing.

### CROSS REFERENCE TO RELATED APPLICATION

This application claims the benefit of U.S. Provisional Application No. 63/743,933, filed Jan. 10, 2025.

### FIELD OF THE DISCLOSURE

The present disclosure is directed to a contact system for rotational shutoff of a night-vision device.

### BACKGROUND OF THE ART

A night-vision device can be an opto-electronic device that allows for visualization of objects in low levels of light. Commonly, night-vision devices are referred to as night optical/observation devices (NODs). Night-vision devices can be of two main classifications, including image intensification and thermal imaging. Night-vision devices utilizing image intensification were first conceived prior to World War II. Such devices allowed for amplification of existing light by approximately 1,000 times. However, these devices were bulky and cumbersome and further required use of an infrared illuminator to function, limiting their use in a wartime environment. Such devices are oftentimes referred to as “Generation 0” devices.

“Generation 1” devices were developed in the mid 1960's and did not require an infrared illuminator. The size of the Generation 1 devices decreased drastically from prior Generation 0 devices, more easily allowing for their use in the battlefield. Since the introduction of Generation 1 night-vision devices, great advancements have occurred, allowing for devices that are small enough for individuals to wear on their head, while amplifying available light by 50,000 times or more.

Many current generation night-vision devices include single, dual, or quad image intensification tubes that are disposed in a housing. The housing can be configured such that it is mountable to a helmet. Corresponding mounts can allow for a detachable interface between the night-vision device and a hard helmet (e.g., bump or ballistic helmet) or a soft helmet (e.g., head strap). Such mounts can allow for the night-vision device to be rotated up along a sagittal plane of the user's body via a hinge mechanism included in the mount. Some night-vision housings provide a rotational hinge, which can allow for the single, dual, or quad image intensification tubes to be rotated along a coronal plane of the user's body, such that the tube(s) are rotated outward and upward, no longer being positioned in front of the user's eyes. The rotational hinge can allow for a user to quickly rotate the tube outward and upward out of their line of sight into a rotationally stowed position, which can be beneficial when transitioning to a new environment with increased lighting. Conversely, when entering a new environment with decreased lighting, the rotational hinge can allow for a user to quickly rotate the tube inward and downward into their line of sight, from the rotationally stowed position.

Due to the nature of night vision tubes and their extreme sensitivity to light, the tubes can be damaged as a result of exposure to light sources. Accordingly, when transitioning the one or more tubes into the rotationally stowed position, it can also be important to ensure that a power source to each one of the tubes is disengaged, thereby helping to prevent light damage to the intensifier tubes by ensuring that they are turned off and further preventing unnecessary battery drain. Some designs for rotational shutoffs utilize sensors (e.g., Hall effect sensors) to sense when the tube has been rotated into a stowed position. However such sensors can be expensive and prone to failure in challenging environmental conditions. Some designs can utilize a wired connection between a bridge and tube housing, however, upon repetitive rotation of the housing, such wires can become damaged, resulting in failure. Embodiments of the present disclosure address the shortcomings of existing rotational shutoffs for night-vision devices.

### SUMMARY OF THE INVENTION

Embodiments of the present disclosure include a night vision device. In some embodiments, the night vision device can include a first housing. In some embodiments, the night vision device can include a second housing, wherein the first housing is configured to rotate relative to the second housing about a pivot point that defines an axis about which the first housing rotates. In some embodiments, the night vision device can include a rotational electrical circuit disposed about the pivot point, wherein the rotational electrical circuit includes a contact track fixed with respect to the second housing. In some embodiments, the night vision device can include an electrical contact fixed with respect to the first housing, wherein rotation of the first housing about the pivot point causes selective electrical engagement between the electrical contact and the contact track, dependent on a rotational position of the first housing, and wherein the selective electrical engagement between the electrical contact and the contact track is established or interrupted based on the rotational position of the first housing.

Embodiments of the present disclosure include a night vision device. In some embodiments, the night vision device can include a night vision pod. In some embodiments, the night vision device can include a bridge portion, wherein the night vision pod is configured to rotate relative to the bridge portion about a pivot point that defines an axis about which the night vision pod rotates. In some embodiments, the night vision device can include a rotational electrical circuit disposed about the pivot point, wherein the rotational electrical circuit includes: a plurality of contact tracks disposed on a first circuit board, the first circuit board being in fixed relation to the bridge portion, wherein the contact tracks include a plurality of arcuate paths disposed at a common radial distance from the pivot point about which the night vision pod rotates; and a plurality of electrical contacts disposed on a second circuit board, the second circuit board being in fixed relation to the night vision pod, wherein the plurality of electrical contacts are configured for selective electrical engagement with respective ones of the plurality of contact tracts, dependent on a rotational position of the night vision pod with respect to the bridge portion.

Embodiments of the present disclosure can include a night vision device. In some embodiments, the night vision device can include a first housing. In some embodiments, the night vision device can include a second housing, the first housing being rotatable relative to the second housing about a pivot point defining a rotational axis. In some embodiments, the night vision device can include a rotational electrical circuit disposed about the pivot point, wherein the rotational electrical circuit includes: a contact track disposed on a first plane and fixed with respect to the second housing; and an electrical contact disposed on a second plane and fixed with respect to the first housing, wherein the first plane is parallel with the second plane, wherein rotation of the first housing about the pivot point causes selective electrical engagement between the electrical contact and the contact track, dependent on a rotational position of the first housing, and wherein the selective electrical engagement between the electrical contact and the contact track is established or interrupted based on the rotational position of the first housing.

### BRIEF DESCRIPTION OF THE DRAWINGS

FIG. 1A depicts an isometric view of a night vision device, in accordance with embodiments of the present disclosure.

FIG. 1B depicts an isometric view of the night-vision device of FIG. 1A, where a night vision pod and associated pod topper have been removed, in accordance with embodiments of the present disclosure.

FIG. 1C depicts a forward facing view of the night-vision device of FIG. 1B from the perspective of a user, in accordance with embodiments of the present disclosure.

FIG. 2A depicts a forward facing isometric view of a forward bridge portion and a pair of pod-toppers in a deployed configuration, in accordance with embodiments of the present disclosure.

FIG. 2B depicts a forward facing isometric view of a forward bridge portion and a pair of pod-toppers in a stowed configuration, in accordance with embodiments of the present disclosure.

FIG. 3A depicts an isometric cut-away view of a pod topper and forward bridge portion, in accordance with embodiments of the present disclosure.

FIG. 3B further depicts an isometric cut-away view of the pod topper of FIG. 3A, with forward bridge portion removed, in accordance with embodiments of the present disclosure.

FIGS. 3C and 3D further depict isometric cut-away views of the pod topper of FIGS. 3A and 3B, in accordance with embodiments of the present disclosure.

FIG. 3E depicts a side cut-away view of the pod topper of FIGS. 3A to 3D, in accordance with embodiments of the present disclosure.

FIG. 3F depicts a side cut-away view of the pod topper and forward bridge portion of FIG. 3A, in accordance with embodiments of the present disclosure.

FIG. 3G depicts an isometric frontal view of the pod topper with arm board, in accordance with embodiments of the present disclosure.

FIG. 3H depicts a rear facing view of the pod topper with arm board, in accordance with embodiments of the present disclosure.

FIG. 3I depicts an isometric cut-away view of the pod topper in a deployed configuration and forward bridge portion, in accordance with embodiments of the present disclosure.

FIG. 3J depicts an isometric cut-away view of the pod topper in a stowed configuration and forward bridge portion, in accordance with embodiments of the present disclosure.

FIG. 4A depicts an isometric view of an arm board, in accordance with embodiments of the present disclosure.

FIG. 4B depicts a frontal view of the forward bridge portion with front board, in accordance with embodiments of the present disclosure.

FIG. 4C depicts a frontal view of the arm board depicted in FIG. 4A and the forward bridge portion with front board depicted in FIG. 4B in a deployed configuration, in accordance with embodiments of the present disclosure.

FIG. 4D depicts a frontal view of the arm board depicted in FIG. 4A and the forward bridge portion with front board depicted in FIG. 4B in a stowed configuration, in accordance with embodiments of the present disclosure.

FIG. 5A depicts a detailed frontal view of the contact tracks disposed on the front board, in accordance with embodiments of the present disclosure.

FIG. 5B depicts a circuit diagram with respect to operation of the night vision device, in accordance with embodiments of the present disclosure.

FIG. 5C further depicts a circuit diagram with respect to operation of the night vision device, in accordance with embodiments of the present disclosure.

FIG. 6A depicts an isometric cut-away view of the forward bridge portion and pod topper in a stowed position, in accordance with embodiments of the present disclosure.

FIG. 6B depicts a top cut-away view of the forward bridge portion and pod topper in a stowed position, in accordance with embodiments of the present disclosure.

### DETAILED DESCRIPTION

Various embodiments are described herein of various apparatus and/or systems. Numerous specific details are set forth to provide a thorough understanding of the overall structure, function, manufacture, and/or use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” “an exemplary embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” “in an exemplary embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

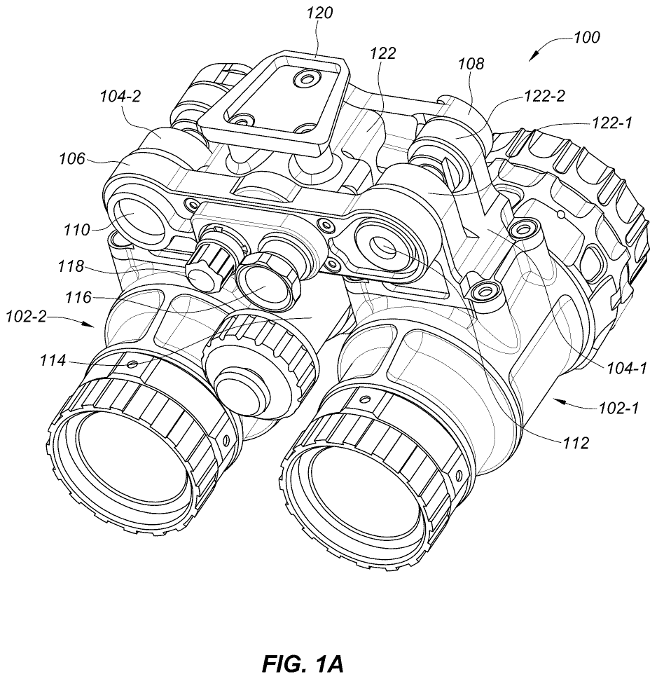

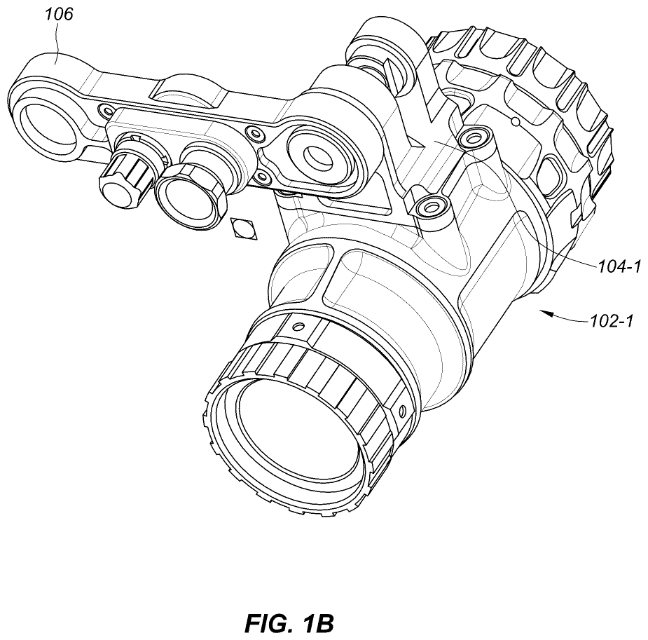

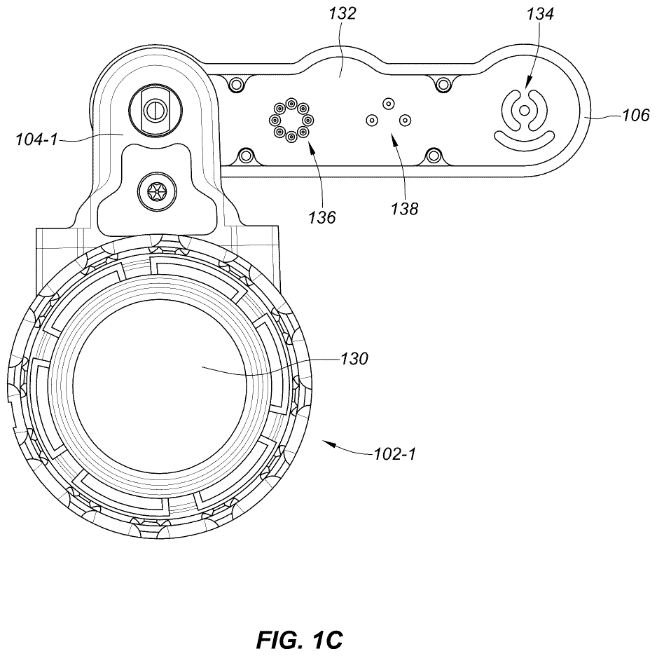

FIG. 1A depicts an isometric view of a night vision device 100, in accordance with embodiments of the present disclosure. Although some embodiments as depicted utilize a dual intensification tube setup, embodiments of the present disclosure can include single, dual, or quad image intensification tubes. For example, the night vision device 100 can include one or more night vision pods 102-1, 102-2, which can include a housing in which one or more intensifier tubes are disposed. Although image intensification based night vision is generally discussed herein, embodiments of the present disclosure can be applicable to various forms of night vision, including, but not limited to thermal imaging based night vision. As depicted, each one of the night vision pods 102-1, 102-2 can include an ocular lens and an objective lens. With respect to FIG. 1A, the first night vision pod 102-1 can be coupled with the second night vision pod 102-2 via a connecting bridge, which can include a forward bridge portion 106 and a rear bridge portion 108. The night vision pods 102-1, 102-2 can each be connected to the connecting bridge via respective first and second pod toppers 104-1, 104-2.

As further depicted in FIG. 1A, a pair of infrared illuminators 110, 112 can be disposed in the forward bridge portion 106. In some embodiments a first of the infrared illuminators can be a high intensity illuminator 110 and a second of the infrared illuminators can be a proximity infrared illuminator 112, each of which can be selectively activated via a power switch 116, as further discussed herein. The night vision device 100 can include a battery compartment 114, which can house a battery for powering the night vision device and/or input for connection of an external power supply. The connecting bridge further includes power switch 116 (e.g., rotary dial) that can control activation of each one of the intensifier tubes and also control activation of each one of the infrared illuminators 110, 112. In some embodiments, the power switch 116 can control activation of other features or accessories associated with the night vision device 100. In some embodiments, the connecting bridge can further include a manual gain control 118 (e.g., rotary dial) which can control an amount of gain with respect to the intensifier tubes. For example, a ratio of an output signal produced by the intensifier tubes versus an input signal provided to the intensifier tubes can be adjusted via the manual gain control 118. While a rotational power switch and manual gain control are depicted, other types of switches can be utilized.

As depicted in FIG. 1A, first and second pod toppers 104-1, 104-2 can be fastened to a respective one of the night vision pods 102-1, 102-2. Each of the pod toppers 104 can include one or more mounting tabs 124-1, 124-2, which are depicted with respect to the pod topper 104-1. As depicted, the mounting tabs 124-1, 124-2 can be coupled to respective ones of the forward bridge portion 106 and rear bridge portion 108 such that the pod toppers 104-1, 104-2 and thus night vision pods 102-1, 102-2 can rotate with respect to the forward and rear bridge portions 106, 108. For example, as further depicted and discussed herein, the pod toppers 104-1, 104-2 and/or night vision pods 102-1, 102-2 can be configured to rotate relative to the forward and rear bridge portions 106, 108 about a pivot point that defines an axis about which the pod toppers 104-1, 104-2 and/or night vision pods 102-1, 102-2 rotate.

In some embodiments, the night vision device can include a mount 120 (e.g., dovetail mount), which can allow for connection of the night vision device to a hard or soft helmet. As depicted, the forward bridge portion 106 can be connected to the rear bridge portion 108 via a connective portion 122 to which the mount 120 can be coupled.

FIG. 1B depicts an isometric view of the night-vision device of FIG. 1A, where a night vision pod 102-2 and associated pod topper 104-2 have been removed, in accordance with embodiments of the present disclosure. FIG. 1B depicts the night vision pod 102-1 connected to the forward bridge portion 106 via the pod topper 104-1.

FIG. 1C depicts a forward facing view of the night-vision device of FIG. 1B from the perspective of a user (e.g., looking through the ocular lens 130), in accordance with embodiments of the present disclosure. As depicted, a front board 132 (e.g., circuit board) can be disposed within the forward bridge portion 106. In some embodiments, in addition to or in place of the front board 132, a rear board can be included in the rear bridge portion 108 and can include the same or similar features to those discussed in relation to the front board 132. In some embodiments, the front board 132 can be formed from a nonconductive material (e.g., polymer, fiberglass) that is rigid or semi-flexible and can have a number of electrical contacts disposed thereon, which are associated with operation of the night vision device 100. As further discussed herein, the front board 132 can include contact tracks 134, which can be configured to provide a rotational power shutoff for the intensifier tubes and/or other electrical components of the night vision device (e.g., infrared illuminators). The front board 132 can further include manual gain contacts 136 and power contacts 138. The manual gain contacts 136 can include a plurality of manual gain contacts, which can be used with a rotary potentiometer switch. As depicted, the manual gain contacts 136 can be associated with a rotary potentiometer switch (e.g., eight position rotary potentiometer switch), which can utilize a number of resistors to control a manual gain of the intensifier tubes.

The power contacts 138 can include three electrical contacts, one of which can be associated with a power supply to the intensifier tubes, one of which can be associated with power supply to the high intensity infrared illuminator and one of which can be associated with power supply to the proximity infrared illuminator. As discussed herein, fewer or greater than three electrical power contacts can be included on the front board 132, based on a number of elements for which control of power is desired.

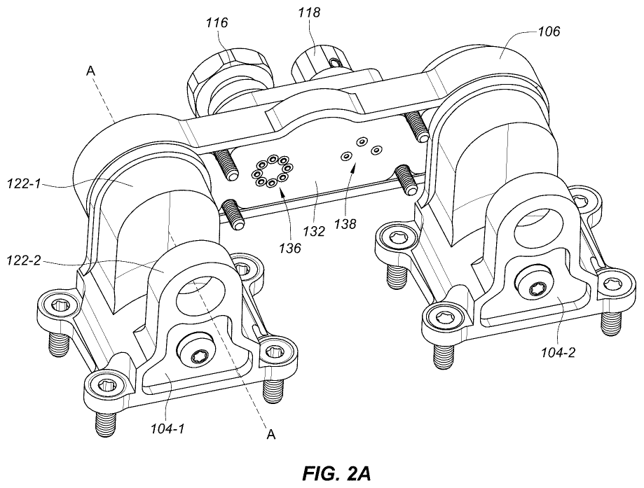

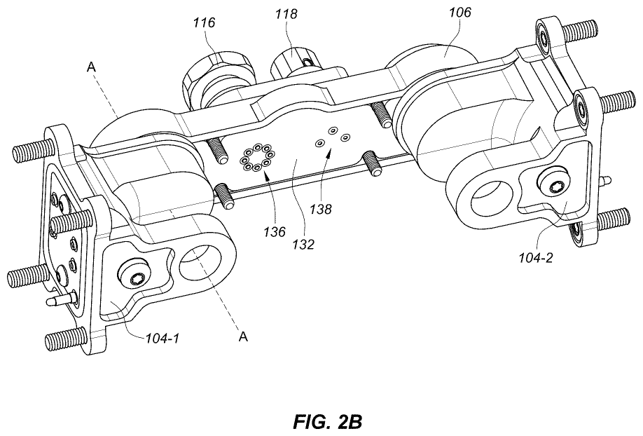

FIG. 2A depicts a forward facing isometric view of a forward bridge portion 106 and a pair of pod-toppers 104-1, 104-2 in a deployed configuration with first and second mounting tabs 122-1, 122-2, in accordance with embodiments of the present disclosure. FIG. 2A further depicts front board 132 with manual gain contacts 136 and power contacts 138. In the deployed configuration, power can be supplied to each one of the intensifier tubes (depicted in FIGS. 1A to 1C) via a rotational power switch 116, as further discussed herein.

As depicted, the interface between the front bridge portion 106 and the first mounting tab 122-1 can define a pivot point, such that the pod topper 104-1 can be configured to rotate relative to the forward bridge portion 106 about the pivot point. In some embodiments, the pod topper 104-1 can rotate about an axis AA, as depicted in FIG. 2A. In some embodiments, a mating surface can be defined between the pod topper 104-1 and the front bridge portion 106, such that the first mounting tab 122-1 and the front bridge portion 106 can maintain rotational alignment with one another. As further depicted in FIG. 1A, a fastener (e.g., nut and bolt) can couple the second (e.g., rear) mounting tab 122-2 with the rear bridge portion, maintaining rotational alignment and axial alignment along the axis AA. Due to the manner in which the front bridge portion 106 and the first (e.g., forward) mounting tab 122-1 are attached to one another, rotational alignment may be maintained between the front bridge portion 106 and the first mounting tab 122-1 and axial alignment can also be maintained between the front bridge portion 106 and the first mounting tab 122-1 as a result of the fixed relationship between the front bridge portion 106 and rear bridge portion 108; the fixed relationship between the forward mounting tab 122-1 and rear mounting tab 122-2; and the fastener connecting the rear mounting tab 122-2 with the rear bridge portion 108.

FIG. 2B depicts a forward facing isometric view of a forward bridge portion 106 and a pair of pod-toppers 104-1, 104-2 in a stowed configuration, in accordance with embodiments of the present disclosure. FIG. 2A further depicts front board 132 with manual gain contacts 136 and power contacts 138. In the stowed configuration, power to each one of the intensifier tubes (depicted in FIGS. 1A to 1C) can be disconnected through a rotational shutoff switch, as further discussed herein.

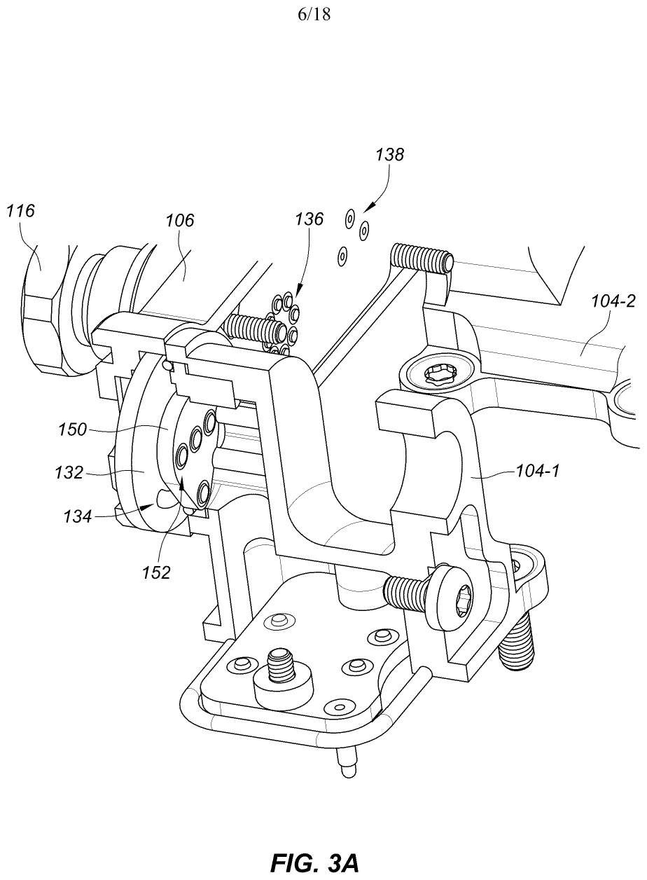

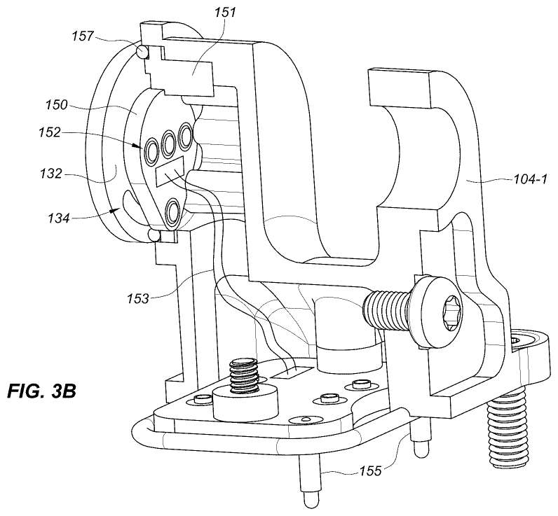

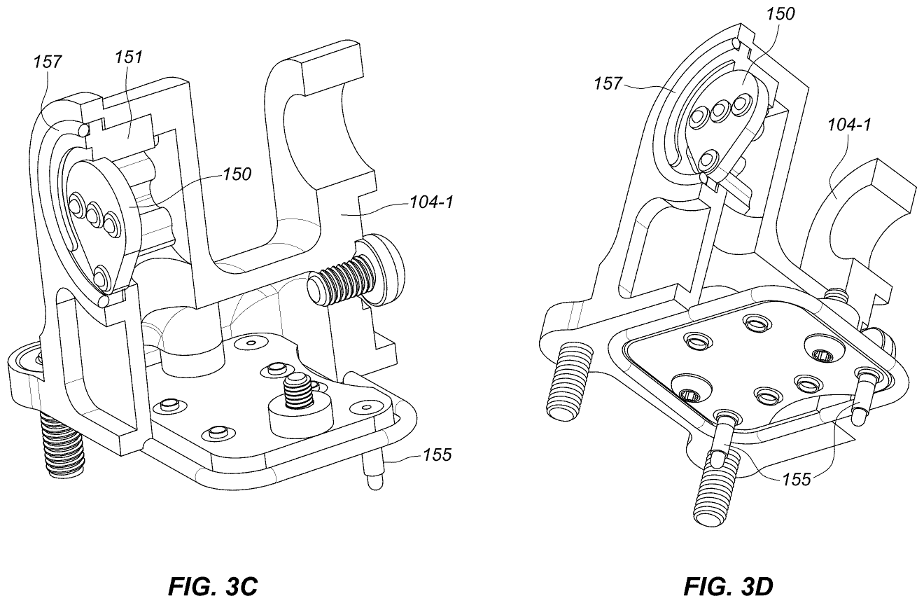

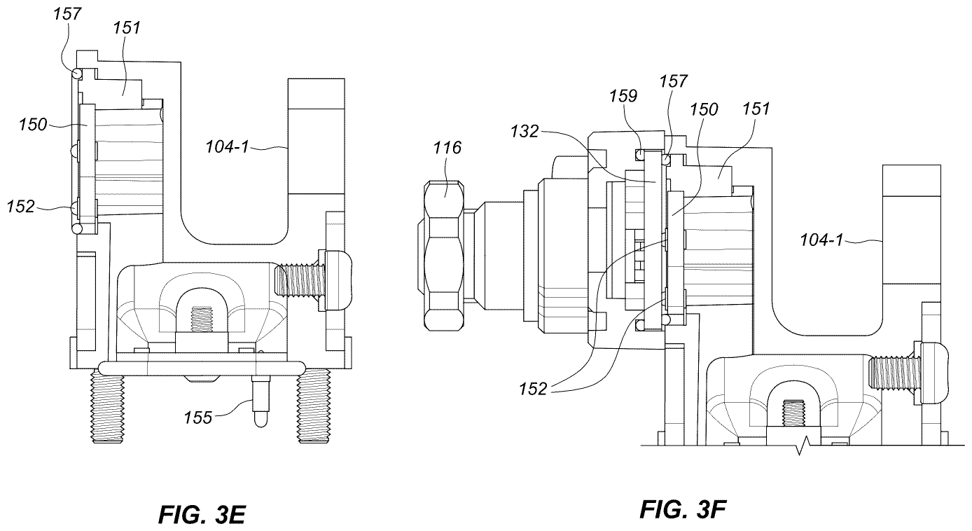

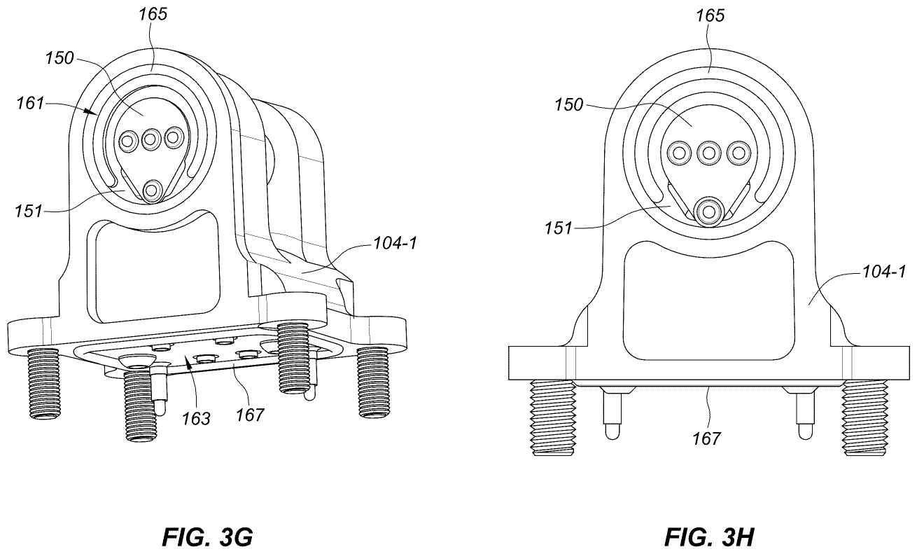

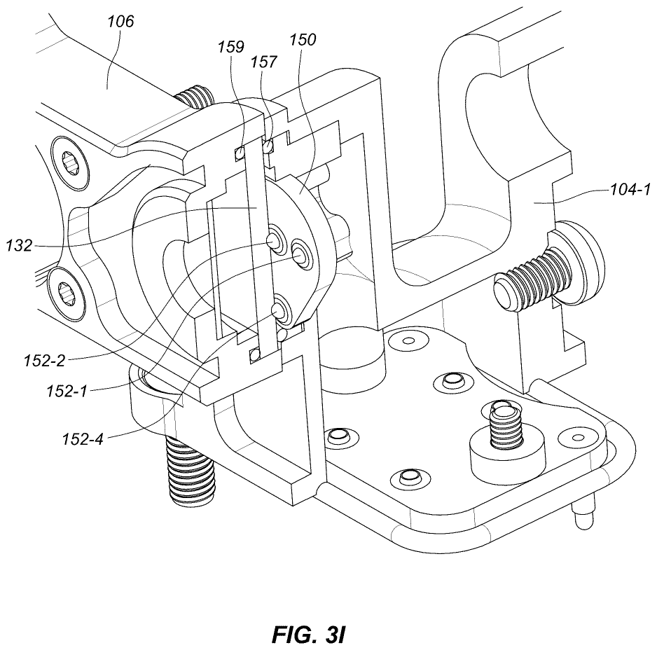

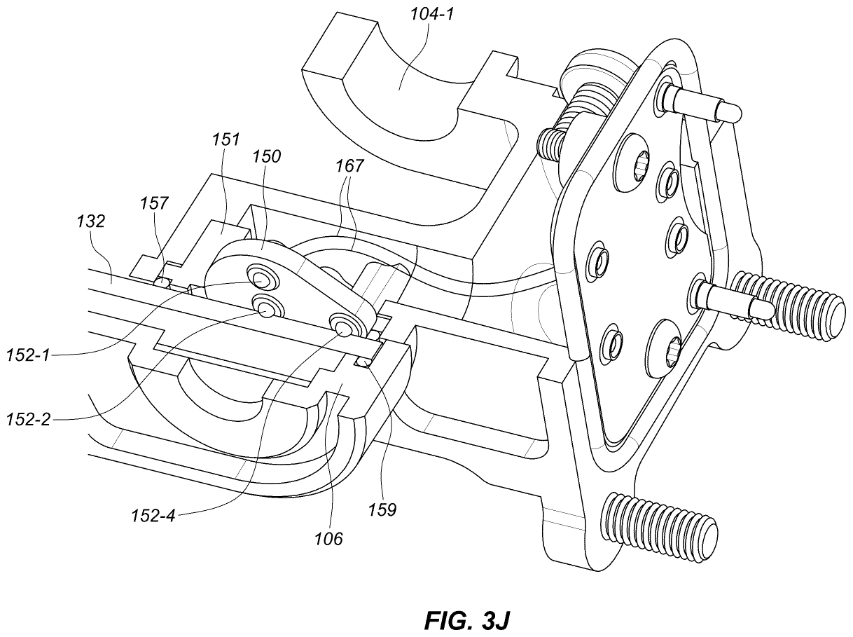

FIG. 3A depicts an isometric cut-away view of a pod topper 104-1 and forward bridge portion 106, in accordance with embodiments of the present disclosure. As further depicted, FIG. 3A further depicts interaction between arm board 150 and the front board 132, which together define a rotational electrical circuit. For example, the arm board 150 can include a number of electrical contacts 152, which correspond to contact tracks 134 disposed on the front board 132, as further shown in FIG. 1C and discussed herein. In some embodiments, each of the electrical contacts 152 can include a pogo pin that contacts a corresponding one of the contact tracks 134 disposed on the front board 132. The arm board 150 can be rotationally fixed with respect to the pod topper 104-1, such that when the pod topper 104-1 is rotated into a stowed position, the electrical contacts 152 also rotate in relation to the contact tracks 134. Thus, dependent on the particular rotation of the electrical contacts 152 in relation to the contact tracks 134, particular circuits can be electrically coupled or disconnected, thereby allowing for power supplied to the night vision device and in particular the intensifier tubes to be controlled.

FIG. 3B further depicts an isometric cut-away view of the pod topper of FIG. 3A, with forward bridge portion removed, in accordance with embodiments of the present disclosure. As depicted, the pod topper 104-1 can include a board holder 151, in which the arm board 150 can be inserted. In some embodiments, the arm board 150 can be shaped in a tear drop shape to allow room for each of the electrical contacts 152 to be positioned on the arm board 150, while also mechanically fixing the arm board 150 into a corresponding recess formed in the board holder 151, thereby preventing rotation of the arm board 150 in relation to the pod topper 104-1. A corresponding depiction of front board 132 has been provided, which further illustrates corresponding contact tracks 134. In some embodiments, a seal 157 (e.g., joint O-ring) can be disposed about a perimeter of the board holder 151, thereby providing a water and dust proof seal in a chamber housing the contact tracks 134 and joint contacts (e.g., electrical contacts 152).

As further depicted, in FIG. 3B, a pair of electrical cables 153 can be connected with the joint contacts (e.g., electrical contacts (152)) of the arm board (150). Upon rotation of the pod topper (104-1), the joint contacts (e.g., electrical contacts (152)) can be positioned with respect to the contact tracks (134), such that a circuit is completed, providing power to tube contacts 155 and thus the intensifier tubes (not depicted).

FIGS. 3C and 3D further depict isometric cut-away views of the pod topper of FIGS. 3A and 3B, in accordance with embodiments of the present disclosure. FIG. 3E depicts a side cut-away view of the pod topper of FIGS. 3A to 3D, in accordance with embodiments of the present disclosure. FIG. 3F depicts a side cut-away view of the pod topper and forward bridge portion of FIG. 3A, in accordance with embodiments of the present disclosure. As depicted, the front board 132 and the arm board 150 are in close proximity to one another such that the electrical contacts 152 are in contact with contact tracks, further depicted and discussed herein. As depicted, the front board 132 and the arm board 150 can define respective planes, which are parallel with one another. Accordingly, as the pod topper 104-1 rotates around the axis AA, depicted in FIGS. 2A and 2B, the board holder 151 and thus the arm board 150 can rotate about the axis AA, causing selective electrical engagement between the electrical contacts 152 and the contact tracks.

FIG. 3G depicts an isometric frontal view of the pod topper 104-1 with arm board 150 disposed in board holder 151, in accordance with embodiments of the present disclosure. FIG. 3H depicts a rear facing view of the pod topper 104-1 with arm board 150, in accordance with embodiments of the present disclosure. As depicted, seals (e.g., O-rings) can be disposed around the board holder 151 and/or a bottom portion of the pod topper, which interfaces with an intensifier tube, thereby defining sealed areas 161, 163, which can be impervious to fluids crossing a barrier created by respective seals. In some embodiments a night vision pod 102 (FIG. 1A) can be attached to the sealed area 163 of the pod topper 104-1, thereby preventing moisture from entering the sealed area.

FIG. 3I depicts an isometric cut-away view of the pod topper 104-1 in a deployed configuration and forward bridge portion 106, in accordance with embodiments of the present disclosure. Further depiction of the arm board 150, along with electrical contacts 152-1, 152-2, 152-4 is provided. A fourth electrical contact 152-4 is hidden from view. For ease, electrical contacts (e.g., pogo pins) 152-1, 152-2, 152-4 are referred to in the plural as electrical contacts 152. As can be seen in FIG. 3I, the electrical contacts 152 can be disposed such that they contact the contact tracks, which are hidden from view. In some embodiments, the electrical contacts 152 can be pogo pins, which are housed in the arm board 150. In some embodiments, each one of the pogo pins can be spring loaded, such that a tensioning force is created in a direction that is transverse to a plane along which the arm board 150 is defined. As a result of the tensioning force, each one of the pogo pins can be forced in a direction towards which the contact tracks on the front board are disposed, thereby ensuring that each one of the pogo pins can remain in contact with the front board and contact tracks.

FIG. 3J depicts an isometric cut-away view of the pod topper 104-1 in a stowed configuration and forward bridge portion 106, in accordance with embodiments of the present disclosure. As depicted, the pod topper 104-1 can include a board holder 151, in which the arm board 150 can be inserted. As further depicted, the pogo pins 152-1, 152-2, 152-4 are depicted as protruding from a forward side of the arm board 150. In some embodiments, the arm board 150 can be configured as a tear drop shape to allow room for each of the electrical contacts 152 to be positioned on the arm board 150, while also mechanically fixing the arm board 150 into a corresponding recess formed in the board holder, thereby preventing rotation of the arm board 150 in relation to the pod topper 104-1. Although the arm board is depicted as a tear drop shape, the arm board 150 can be other shapes, such as a square, oval, rectangle, triangle, etc. In some embodiments the arm board 150 can be circular shaped. In such an embodiment where the arm board 150 is circular shaped, the arm board 150 can include other mechanisms to prevent rotation of the arm board with respect to the arm board holder. In some embodiments, a seal (e.g., joint O-ring) can be disposed about a perimeter of the board holder, thus providing a water and dust proof seal in a chamber housing the contact tracks 134 and joint contacts (e.g., electrical contacts 152).

As further depicted, in FIG. 3J, a pair of electrical cables can be connected with the joint contacts (e.g., electrical contacts 152) of the arm board 150. Upon rotation of the pod topper 104-1, the electrical contacts 152 can be positioned with respect to the contact tracks 134, such that a circuit is completed, providing power to tube contacts and thus the intensifier tubes (not depicted). Alternatively, upon rotation of the pod topper 104-1, the electrical contacts 152 can be positioned with respect to the contact tracks 134, such that a circuit is interrupted, cutting power to tube contacts and thus the intensifier tubes (not depicted). The electrical cables depicted in FIG. 3J can remain static upon rotation of the pod topper. Thus, embodiments of the present disclosure can prevent repetitive flexing of the cables, which can cause them to fray or break.

As depicted in FIGS. 3I and 3J, the arm board 150 can define a first plane on which the electrical contacts 152 are disposed and the forward board 132 can define a second plane on which the contact tracks (not depicted) are disposed. As further depicted, the first plane can be parallel or substantially parallel with the second plane. In some embodiments, even if the arm board 150 and the forward board 132 are themselves not parallel, the interfaces between the electrical contacts 152 and the contact tracks can be arranged such that they are substantially parallel and can make contact with one another as the arm board 150 and the forward board 132 rotate with respect to one another.

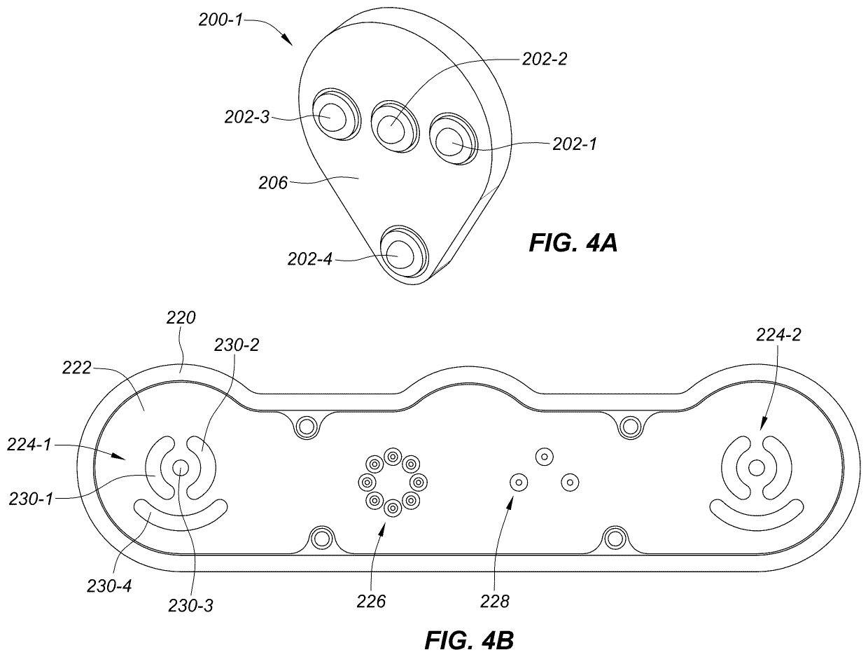

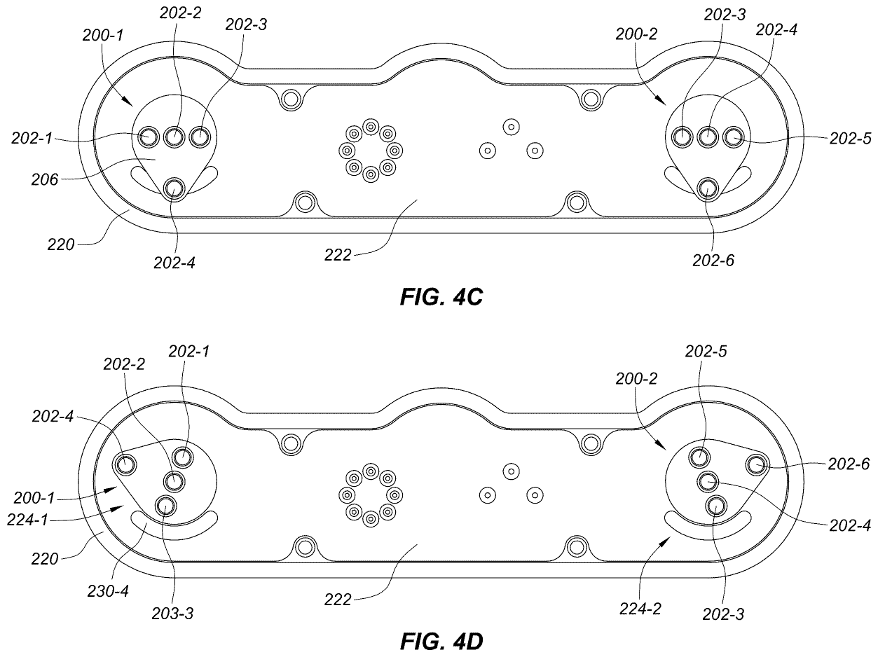

FIG. 4A depicts an isometric view of an arm board 200-1, in accordance with embodiments of the present disclosure. In some embodiments, the arm board 200-1 can be formed from a non-conductive substrate (e.g., fiberglass, polymer, etc.) that is rigid or semi-flexible. The arm board 200-1 can define one or more vias through which a conductive insert can be disposed. In some embodiments, the conductive insert can be one or more pogo pins 202-1, 202-2, . . . , 202-4, hereinafter referred to in the plural as pogo pins 202. In some embodiments, the conductive insert can be a liner formed from a conductive material (e.g., copper), into which the pogo pins 202 can be inserted. The pogo pins 202 can be disposed in the arm board 200-1, such that each of the pogo pins 202 protrude from a front face 206 of the arm board 200-1 that is flat, thereby allowing contact with corresponding contact tracks defined on a front board, as further discussed herein.

FIG. 4B depicts a frontal view of the forward bridge portion 220 with front board 222, in accordance with embodiments of the present disclosure. In some embodiments, the front board 222 can include manual gain contacts 226. As discussed herein, the manual gain contacts 226 can include a plurality of electrical contacts that can be utilized in relation to a rotary potentiometer switch to control manual gain of the electrically coupled intensifier tubes. In some embodiments, the front board 222 can include power contacts 228. The power contacts 228 can include three electrical contacts, one of which is associated with a power supply to the intensifier tubes, one of which is associated with power supply to a high intensity infrared illuminator, and one of which is associated with power supply to the proximity infrared illuminator, as discussed herein. In some embodiments, additional electrical contacts can be provided for electrical control of additional features included on the night vision device (e.g., thermal imaging, additional lights, etc.).

In some embodiments, the forward board 222 can include contact tracks 224-1, 224-2, which are disposed on a flat face of the forward board 222, which can correspond to a flat face of the arm board 200-1. The contact tracks 224 can be responsible for selectively providing power to the intensifier tubes and/or other components of the night vision device and/or manual gain associated with the intensifier tubes, based on the relative positioning of the arm boards 200-1, 200-2 respectively positioned in relation to each contact track 224-1, 224-2. For example, a first arm board 200-1 can be positioned in relation to the first contact track 224-1 and a second arm board 200-2 can be positioned in relation to the second contact track 224-2, each corresponding arm board and contact track responsible for controlling power to corresponding intensifier tubes. Selective control of electrical contact between pogo pins 202 and corresponding contact tracks can be controlled by circumferential gaps existing between each contact track/group of contact tracks. For example, a large circumferential gap can be defined on either side of the power contact track 230-4, where the power pogo pin 202-4 does not contact the power contact track 230-4, when rotated accordingly. In relation to the manual gain contact tracks 230-1, 230-2, a pair of circumferential gaps can be located between the manual gain contact tracks 230-1, 230-2, where the manual gain pogo pins 202-1, 202-3 do not contact the manual gain contact tracks 230-1, 230-2, when rotated accordingly.

In some embodiments, the pogo pins 202-1, 202-3 and contact tracks 230-1, 230-2 can be associated with operation of manual gain of the night vision device. In some embodiments, the pogo pin 202-2 and contact track 230-3 can be associated with a ground of the night vision device. In some embodiments, the pogo pin 202-4 and contact track 230-4 can be associated with a power supply of the night vision device.

In relation to FIGS. 4A and 4B, the one or more pogo pins 202 can make contact with respective ones of the contact tracks 224-1, depending on a rotation of a correspondingly connected intensifier tube via a pod topper. For example, in relation to FIG. 1A, when the pod toppers 104-1, 104-2 are rotated in a deployed configuration, such that the night vision pods 102-1, 102-2 are located in front of a user's eyes (such as a configuration depicted in FIG. 2A), the pogo pin 202-4 associated with power supply to the night vision device can make electrical contact with the contact track 230-4 associated with the power supply of the night vision device. Such a configuration will be apparent when referencing FIG. 4C.

As discussed and depicted herein, in some embodiments, a first housing (e.g., pod topper and/or night vision pod) can rotate relative to a second housing (e.g., bridge portion) about a pivot point that defines an axis (e.g., axis AA in FIGS. 2A and 2B) about which the first housing rotates. In some embodiments, the axis AA depicted in FIGS. 2A and 2B can pass through the ground contact track 230-3 and the associated ground pogo pin 202-2, such that upon rotation of the first housing with respect to the second housing and thus the arm board 200-1 with respect to the forward board, the ground pogo pin 202-2 and the ground contact track 230-3 can remain in constant contact. In some embodiments, upon rotation of the first housing about the pivot point, selective electrical engagement between the electrical contact and the contact track can be created, dependent on a rotational position of the first housing. In an example, the selective electrical engagement between the electrical contact and the contact track can be established or interrupted based on the rotational position of the first housing, as depicted by the positioning of the arm boards 200-1, 200-2 and forward board 222 in FIGS. 4C and 4D.

As further depicted in relation to FIG. 4B, the contact tracks 230-1, 230-2, 230-4 can define a conductive arcuate path arranged on the forward board about the pivot point (e.g., location where ground contact track 230-3 is disposed), which can be contacted by the electrical contacts 202-1, 202-3, 202-4, dependent on the rotational position of the first housing. As depicted and discussed, the ground electrical contact 202-2 can be disposed on the arm board 200-1 (e.g., second circuit board) at the pivot point and the ground electrical contact 202-2 can be configured to maintain electrical engagement with a complimentary electrical contact ground contact track 230-3 disposed on the forward board 222 (e.g., first circuit board) irrespective of rotation of the first housing with respect to the second housing.

Although the ground contact track 230-3 is depicted and described as being disposed at a singular point, the ground contact track can in some embodiments be a conductive arcuate path. For example, in some embodiments, the ground contact track can extend in an arcuate fashion over a particular circumference such that contact is made with the ground contact track during a particular rotation of the night vision pod when ground contact is needed for operation of the intensifier tubes.

In some embodiments, as depicted in FIG. 4B, a plurality of conductive arcuate paths can be arranged on the forward board 222 about a pivot point (e.g., ground contact track 230-3). In some embodiments, two or more of the plurality of conductive arcuate paths can be disposed at a common radial distance from the pivot point about which the first housing rotates. For example, as depicted, the first contact track 230-1 and the second contact track 230-2 can be disposed at a common radial distance from the pivot point about which the first housing rotates. In some embodiments, two or more of the plurality of conductive arcuate paths can be disposed at a common radial distance from the pivot point about which the first housing rotates. In some embodiments, two or more of the plurality of conductive arcuate paths are disposed at a different radial distance from the pivot point about which the first housing rotates.

FIG. 4C depicts a frontal view of the arm board depicted in FIG. 4A and the forward bridge portion with front board depicted in FIG. 4B in a deployed configuration, in accordance with embodiments of the present disclosure. In FIG. 4C, each of the pogo pins 202-1, 202-2, 202-3, 202-4 makes electrical contact with a respective manual gain contact track 230-1, 230-2, ground contact track 230-3, and power supply contact track 230-4, thereby allowing for power to be supplied to the intensifier tubes and an associated manual gain to be controlled.

Upon rotation of the night vision pods and associated pod toppers to a stowed position, as depicted in FIG. 2B, the pogo pin 202-4 associated with the power supply can be rotated such that electrical contact between the pogo pin 202-4 and the contact track 230-4 is broken (e.g., disconnected), thereby disconnecting power to the intensifier tube and/or other component(s) associated with the night vision device. Such a configuration will be apparent when referencing FIG. 4D.

FIG. 4D depicts a frontal view of the arm board depicted in FIG. 4A and the forward bridge portion with front board depicted in FIG. 4B in a stowed configuration, in accordance with embodiments of the present disclosure. As depicted in relation to the contact tracks 224-1, as further depicted in FIG. 4B, the power contact track 230-4 can extend about a partial circumference that is revolved about the ground contact track 230-3, such that the associated night vision pod and pod topper can be rotated by a particular amount (e.g., into a stowed position) before power to the image intensifier and/or other component associated with the night vision device is disconnected. In some embodiments, regardless of position of the night vision pods and thus the arm boards 200-1, 200-2, the pogo pins associated with the ground and the ground contact tracks can remain electrically coupled. For example, in relation to FIGS. 4A and 4B, the ground pogo pin 202-2 and ground contact track 230-3 can remain electrically coupled regardless of positioning of the night vision pods, since a center of rotation of the arm board 200-1 revolves about the ground pogo pin 202-2 and ground contact track 230-3. In some embodiments, as depicted in FIG. 4D, electrical contact between the manual gain pogo pins 202-1, 202-3 and manual gain contact tracks 230-1, 230-2 can be broken as well, as a result of the manual gain pogo pins 202-1, 202-3 being disposed in the circumferential gaps between the manual gain contact tracks 230-1, 230-2.

As discussed, behind each arm board 200-1, 200-2 there can be a cable that carries power and signals transmitted through it into a respective image intensifier tube. If more signals and power need to be carried, additional pogo pins on the arm board can be present as well as contact tracks on the front board. Some contact tracks may be on the same diameter if they can overlap, or if other functions making them dependent on each other are turned off by that point in rotation. For example, the manual gain tracks intersect with each other. This is not an issue since the manual gain contact tracks carry an electrical resistance signal, which is the same in either direction, so if the arm board is rotated 180 degrees it will function exactly the same. As depicted, there is a gap in the manual gain tracks. Cutting off the manual gain while the image intensifier is on would be an issue, so this gap is positioned in such a way that the power will be cut well before the pogo pins reach this gap. This can be extended to numerous other functions, or the mechanical limits of the articulation of the housing can keep tracks from intersecting unwanted pins even if they are on the same diameter. In some embodiments, as depicted, the manual gain contact tracks can be disposed about different diameters. In some embodiments, additional tracks can be disposed on additional diameters not depicted, thereby providing for individualized control of power for various other features of the night vision device.

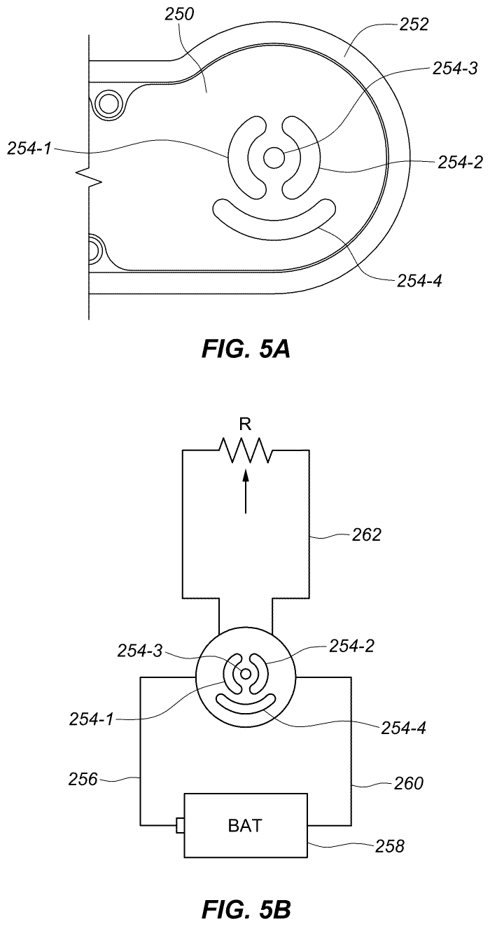

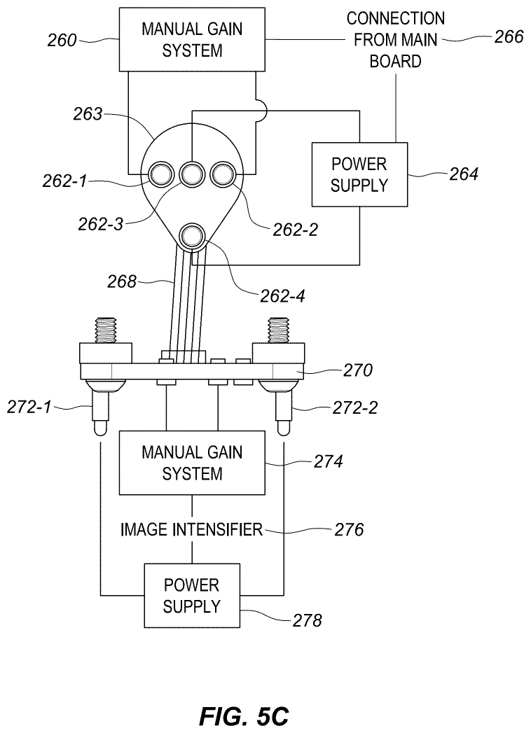

FIG. 5A depicts a detailed frontal view of the contact tracks 254-1, 254-2 (manual gain), 254-3 (ground), and 254-4 (power) disposed on the front board 250, in accordance with embodiments of the present disclosure. As depicted, the front board 250 can be disposed in a recessed area of a forward bridge portion 252 and can include manual gain contact tracks (MG), ground contact track (GND), and power contact track (POW). In some embodiments, power provided to the nightvision device can be approximately 3 volts.

FIG. 5B depicts a circuit diagram with respect to operation of the night vision device, in accordance with embodiments of the present disclosure. In some embodiments, as depicted, the manual gain contact tracks 254-1, 254-2 can be electrically coupled to resistance circuit 262 with resistance R, depicted in FIG. 5B, which can provide a resistance for control of manual gain via a switch (e.g., rotary potentiometer switch). In some embodiments, the power contact track 254-4 can be electrically coupled to power circuit 256 depicted in FIG. 5B, which can provide power to the night vision device. In some embodiments, the ground contact track 254-3 can be electrically coupled to ground circuit 260 depicted in FIG. 5B, which can provide a ground for various electronic components associated with the night vision device. Connections can be made to each one of the contact tracks 254-1, 254-2, 254-3, 254-4 through vias that pass through the front board 250, for example, thus connections to each one of the contact tracks and the associated circuit can be hidden from view in FIG. 5B.

FIG. 5C further depicts a circuit diagram with respect to operation of the night vision device, in accordance with embodiments of the present disclosure. In some embodiments, a manual gain system 260 can be electrically coupled with first and second manual gain electrical contacts 262-1, 262-2 located on arm board 263. The manual gain system 260 can be electrically coupled with power supply portion 264 via a connection from a main board 266. The power supply portion 264 can provide an operating voltage to the image intensifier tube 276. The power supply portion can be connected with the ground electrical contact 262-3 and a power supply electrical contact 262-4. A cable 268 can extend from the arm board 263 and can carry electrical signals and power lines into an interior of a night vision pod that houses the image intensifier. The cable 268 can include multiple insulated conductors which can correspond to manual gain, power, and ground, though additional conductors may be deployed where additional features or signals are required. At the lower end of the assembly (e.g., pod topper/mounting plate 270) are tube contacts 272-1, 272-2, which provide power to the image intensifier 276.

Within the night vision pod, the conductors from cable 268 can terminate at an internal electronics module that includes a manual gain system 274, image intensifier 276, and power supply 278. The manual gain system 274 modulates the operating characteristics of the image intensifier 276 based on the control signal provided through the rotational contact interface. The power supply 278 can condition and stabilize the incoming voltage and can deliver the correct operational voltage to the image intensifier 276.

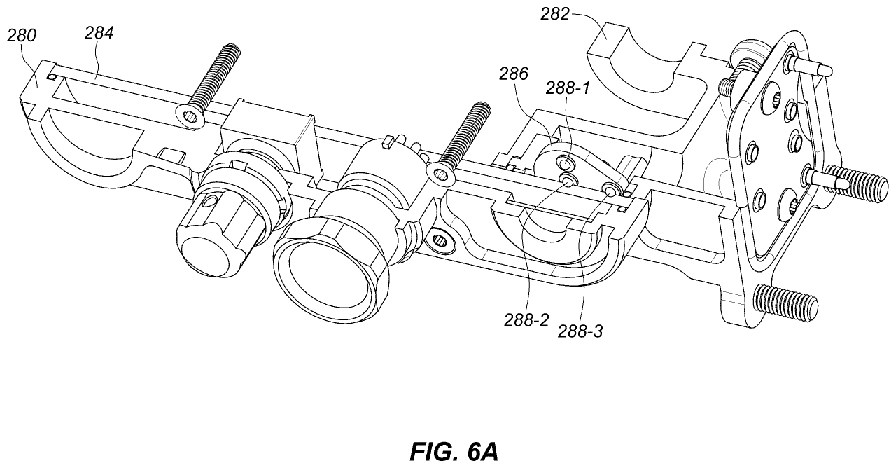

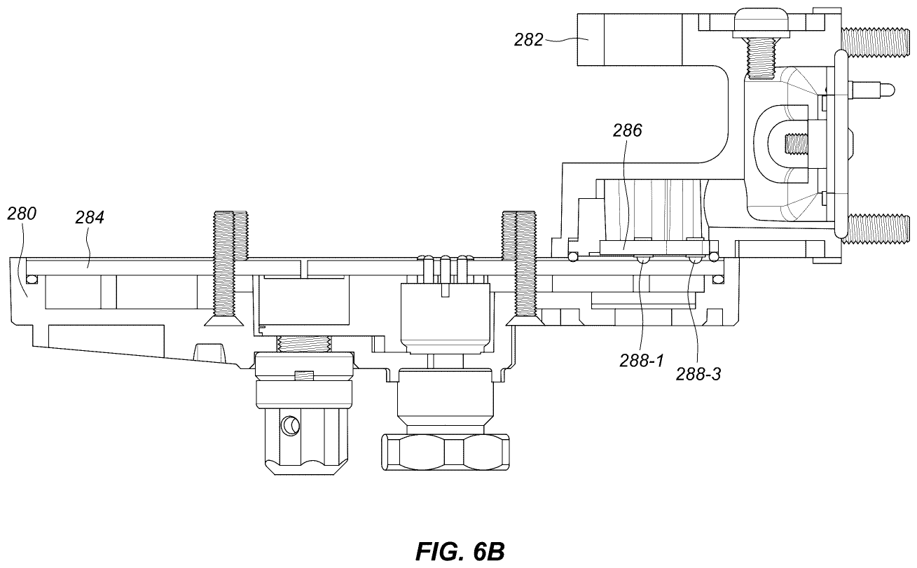

FIG. 6A depicts an isometric cut-away view of the forward bridge portion 280 and pod topper 282 in a stowed position, in accordance with embodiments of the present disclosure. FIG. 6B depicts a top cut-away view of the forward bridge portion 280 and pod topper 282 in a stowed position, in accordance with embodiments of the present disclosure. The forward bridge portion 280 can house the front board 284 on which electrical contact tracks can be disposed, as discussed herein. The pod topper 282 can house arm board 286, which can include electrical contacts that can selectively contact the electrical contact tracks disposed on the front board, as discussed herein. FIGS. 6A and 6B illustrate alternative views of components of the night vision device depicted and discussed herein. Components not expressly discussed with respect to these figures correspond to the structures described and depicted herein and their operation will be readily understood by one of ordinary skill in the art in view of the foregoing description.

It will be appreciated that details of the foregoing embodiments, given for purposes of illustration, are not to be construed as limiting the scope of the present disclosure. Although several embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure, which is further defined in the converted utility application and appended claims. Further, it is recognized that many embodiments may be conceived that do not achieve all the advantages of some embodiments, particularly preferred embodiments, yet the absence of a particular advantage shall not be construed to necessarily mean that such an embodiment is outside the scope of the present disclosure.

What is claimed is:

1. A night vision device, comprising:
a first housing;
a second housing, wherein the first housing is configured to rotate relative to the second housing about a pivot point that defines an axis about which the first housing rotates;
a rotational electrical circuit disposed about the pivot point, wherein the rotational electrical circuit includes
a contact track fixed with respect to the second housing;
an electrical contact fixed with respect to the first housing, wherein rotation of the first housing about the pivot point causes selective electrical engagement between the electrical contact and the contact track, dependent on a rotational position of the first housing, and wherein the selective electrical engagement between the electrical contact and the contact track is established or interrupted based on the rotational position of the first housing.

2. The night vision device of claim 1, wherein the first housing is a pod topper connected to a night vision pod and the second housing is a bridge portion connected to the pod topper via the pivot point.

3. The night vision device of claim 1, wherein the contact track is disposed on a first circuit board, the first circuit board defining a first plane.

4. The night vision device of claim 3, wherein the electrical contact is disposed on a second circuit board, the second circuit board defining a second plane.

5. The night vision device of claim 4, wherein the first plane is parallel with the second plane.

6. The night vision device of claim 5, wherein the contact track defines a conductive arcuate path arranged on the second circuit board about the pivot point.

7. The night vision device of claim 6, wherein the electrical contact is configured to contact the conductive arcuate path, dependent on the rotational position of the first housing.

8. The night vision device of claim 5, wherein:
a ground contact is disposed on the second circuit board at the pivot point; and
the ground contact is configured to maintain electrical engagement with a complimentary electrical contact disposed on the first circuit board irrespective of rotation of the first housing with respect to the second housing.

9. The night vision device of claim 5, wherein the contact track defines a plurality of conductive arcuate paths arranged on the second circuit board about the pivot point.

10. The night vision device of claim 9, wherein two or more of the plurality of conductive arcuate paths are disposed at a common radial distance from the pivot point about which the first housing rotates.

11. The night vision device of claim 9, wherein two or more of the plurality of conductive arcuate paths are disposed at a different radial distance from the pivot point about which the first housing rotates.

12. A night vision device, comprising:
a night vision pod;
a bridge portion, wherein the night vision pod is configured to rotate relative to the bridge portion about a pivot point that defines an axis about which the night vision pod rotates;
a rotational electrical circuit disposed about the pivot point, wherein the rotational electrical circuit includes:
a plurality of contact tracks disposed on a first circuit board, the first circuit board being in fixed relation to the bridge portion, wherein the contact tracks include a plurality of arcuate paths disposed at a common radial distance from the pivot point about which the night vision pod rotates; and
a plurality of electrical contacts disposed on a second circuit board, the second circuit board being in fixed relation to the night vision pod, wherein the plurality of electrical contacts are configured for selective electrical engagement with respective ones of the plurality of contact tracts, dependent on a rotational position of the night vision pod with respect to the bridge portion.

13. The night vision device of claim 12, further comprising a pod topper connected to the night vision pod, wherein the bridge is connected to the pod topper via the pivot point.

14. The night vision device of claim 12, wherein the plurality of contact tracks include:
a first and second contact track associated with a manual gain control of the night vision device and
a third contact track associated with a power control of the night vision device.

15. The night vision device of claim 14, wherein the plurality of electrical contacts include:
a first and second electrical contact associated with the manual gain control of the night vision device, and
a third electrical contact associated with the power control of the night vision device.

16. A night vision device, comprising:
a first housing;
a second housing, the first housing being rotatable relative to the second housing about a pivot point defining a rotational axis;
a rotational electrical circuit disposed about the pivot point, wherein the rotational electrical circuit includes:
a contact track disposed on a first plane and fixed with respect to the second housing;
an electrical contact disposed on a second plane and fixed with respect to the first housing, wherein the first plane is parallel with the second plane, wherein rotation of the first housing about the pivot point causes selective electrical engagement between the electrical contact and the contact track, dependent on a rotational position of the first housing, and wherein the selective electrical engagement between the electrical contact and the contact track is established or interrupted based on the rotational position of the first housing.

17. The night vision device of claim 16, wherein the first housing is a mount connected to a night vision pod and the second housing is a bridge portion.

18. The night vision device of claim 17, further comprising a plurality of contact tracks disposed on the first plane and a plurality of respective electrical contacts disposed on the second plane.

19. The night vision device of claim 18, wherein:
the plurality of contact tracks include a plurality of conductive arcuate paths defined on the first plane, about the rotational axis, and
the plurality of respective electrical contacts are defined on the second plane, about the rotational axis.
